(19) United States
(12) Patent Application Publication
(10) Pub. No.: US 2020/0248540 A1
(43) Pub. Date: Aug. 6, 2020

(54) RECURRENT NEURAL NETWORK MODEL FOR MULTI-STAGE PUMPING

(71) Applicant: Landmark Graphics Corporation, Houston, TX (US)

(72) Inventors: Srinath Madasu, Houston, TX (US); Yogendra Narayan Pandey, Houston, TX (US); Keshava Prasad Rangarajan, Sugar Land, TX (US)

(21) Appl. No.: 16/652,171

(22) PCT Filed: Dec. 18, 2017
(86) PCT No.: PCT/US2017/066974

§ 371 Date: Mar. 30, 2020

(51) Int. Cl. E21B 43/16; G06N 3/08; E21B 47/00; G06N 3/04

(52) U.S. Cl. CPC E21B 43/16; G06N 3/04; E21B 47/006; G06N 3/084

(57) ABSTRACT

A method includes performing a first wellbore treatment operation of a wellbore, determining an operational attribute of the well in response to the first wellbore treatment operation, and determining a predicted response using a recurrent neural network and based on the operational attribute. The method also includes setting a controllable wellbore treatment attribute based, on the predicted response, and performing a second wellbore treatment operation of the wellbore based on the controllable well bore treatment attribute.

### BACKGROUND

The present disclosure relates generally to wellbore operations and, more particularly, to neural network modeling of wellbore operations.

Subterranean treatment operations can include various wellbore treatment operations and drilling operations. In some applications, treatment operations can include hydraulic fracturing. In a hydraulic fracturing treatment, a fracturing fluid is introduced into the formation at a high enough rate to exert sufficient pressure on the formation to create and/or extend fractures therein. The fracturing fluid suspends proppant particles that are to be placed in the fractures to prevent the fractures from fully closing when hydraulic pressure is released, thereby forming conductive channels within the formation through which hydrocarbons can flow toward the wellbore for production. Hydraulic fracturing treatment can occur over a series of stages, wherein fracturing fluid is injected into the well during each stage.

In some circumstances, several factors can interfere with the accurate and fast prediction of the responses to treatment operations or other wellbore operations. Inaccurate predictions can increase the difficulty of setting controllable wellbore treatment attributes to optimize operational performance, while slow predictions can be impractical to make use of due to time constraints of wellbore operation. Systems that increase prediction accuracy and speed can be used to improve the setting of controllable wellbore treatment attributes based on response predictions.

### BRIEF DESCRIPTION OF THE DRAWINGS

Examples of the disclosure can be better understood by referencing the accompanying drawings.

FIG. 1 depicts a diagram of a wellbore system and the underlying formation, according to some embodiments.

FIG. 2 depicts a schematic of a Long Short-Term Memory (LSTM) cell, according to some embodiments.

FIG. 3 depicts a schematic of stacked LSTM cells in a neural network, according to some embodiments.

FIG. 4 depicts a flowchart of operations to train stacked LSTM cells, according to some embodiments.

FIG. 5 depicts a flowchart of operations for predicting values using a recurrent neural network (RNN) of based on operational attributes of a wellbore, according to some embodiments.

FIG. 6 depicts an example graph of surface pressure vs. time, according to some embodiments.

FIG. 7 depicts an example graph of fluid rate vs. time, according to some embodiments.

FIG. 8 depicts an example graph of proppant rate vs. time, according to some embodiments.

FIG. 9 depicts an example graph of a predicted surface pressure compared to a surface pressure vs. time graph, according to some embodiments.

FIG. 10 depicts an example treatment operation being performed in a subterranean formation, according to some embodiments.

FIG. 11 depicts an example drilling operation being performed in a subterranean formation, according to some embodiments.

FIG. 12 depicts an example computer device, according to some embodiments.

### DESCRIPTION OF EMBODIMENTS

The description that follows includes example systems, methods, techniques, and program flows that embody examples of the disclosure. However, it is understood that this disclosure can be practiced without these specific details. For instance, this disclosure refers to long short-term memory (LSTM) neural networks in illustrative examples. Examples of this disclosure can be also applied to other types of recurrent neural network (RNN) architectures such as gated recurrent unit (GRU) neural networks. Other instances, well-known instruction instances, protocols, structures and techniques have not been shown in detail in order not to obfuscate the description.

Various embodiments include predicting one or more responses to various subterranean treatment operations to resolve a time and space variation of the predicted response. Resolving a time and space variation of the predicted response can include determining the response value, a time or time step in which the response occurs, and/or a location in which the response occurs. Subterranean treatment operations can include various wellbore treatment operations and drilling operations. As used herein, the terms “treat,” “treatment,” “treating,” etc. refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, and the like.

Some embodiments include the use of RNN to predict responses of various wellbore treatment operations, such as fracturing, diversion, acidizing applications, etc. along a wellbore to enhance hydrocarbon recovery. A RNN is a neural network wherein connections between cells can form a directed cycle, and can use their internal memory to retain information from previous operations, increasing prediction speed and accuracy. A RNN can be operated in real time during these wellbore treatment operations, thereby allowing for real time adjustments and control. A RNN can predict a response based on a set (i.e., one or more) of operational attributes. An operational attribute can be any type of measurement or approximation related to the well system made before or during a wellbore treatment. One or more controllable wellbore treatment attributes can be set based on the predicted pressure response, wherein a controllable wellbore treatment attribute is an attribute that can be controlled by a user or processor (e.g. surface pump pressure, sand composition, selected particle sizes, stimulation fluid viscosity, etc).

In some embodiments, the RNN can include a stacked long short-term memory (LSTM) neural network. After an iteration of processing inputs at a time step, the cells in a LSTM neural network can contain an internal cell state that can be used to respond more accurately to discontinuities and nonlinearities in a multi variable dataset. In some embodiments, these discontinuities and nonlinearities can include responses that are a result of encountering faults, unexpected formation changes, drilling abnormalities, drilling accidents, or unexpected well treatment incidents. A RNN can provide fast, accurate, and high-resolution predictions by including operations that take advantage of the temporal nature of multivariable wellbore data during multistep wellbore operations. These predictions can be used to set a controllable wellbore treatment attribute such as a fluid flow rate during a treatment stage.

### Example Representation of a Wellbore

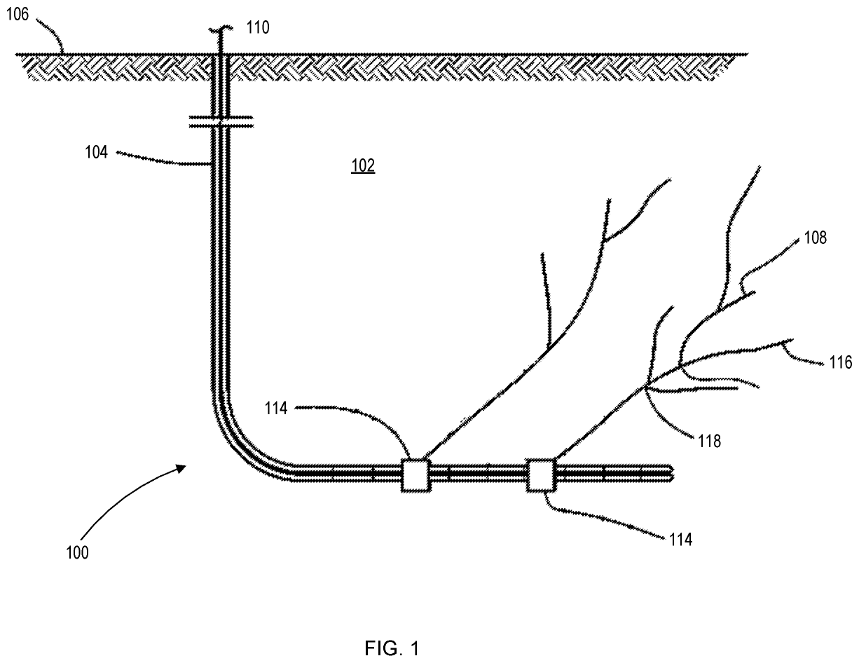

FIG. 1 depicts a diagram of a wellbore system and the underlying formation, according to some embodiments. A wellbore system 100 depicted in FIG. 1 includes a wellbore 104 penetrating at least a portion of a subterranean formation 102. The subterranean formation 102 can include any subterranean geological formation suitable for drilling, fracturing (e.g., shale) acidizing (e.g., carbonate), etc. The subterranean formation 102 can include pores initially saturated with reservoir fluids (e g., oil, gas, and/or water). The wellbore 104 includes one or more injection points 114 where one or more fluids can be injected from the wellbore 104 into the subterranean formation 102. In certain embodiments, the wellbore system 100 can be stimulated by the injection of a fracturing fluid at one or more injection points 114 in the wellbore 104. In certain embodiments, the one or more injection points 114 can correspond to the injection points in a casing of the wellbore 104.

When fluid enters the subterranean formation 102 at the injection points 114, one or more fractures 116 can be opened, and the pressure difference between the solid stress and the fracture 116 causes flow into the fracture 116. As depicted in FIG. 1, the subterranean formation 102 includes at least one fracture network 108 connected to the wellbore 104. The fracture network 108 can include a plurality of junctions and a plurality of fractures 116. The number of junctions and fractures 116 can vary depending on the specific characteristics of the subterranean formation 102. For example, the fracture network 108 can include thousands of fractures 116 or hundreds of thousands of fractures 116.

Operational attributes can be determined before or during a wellbore treatment operation. In certain embodiments, operational attributes can include one or more sensor-acquired measurements, one or more predicted results (e.g., average fracture length), and/or one or more properties of the well (e.g., well radius, casing radius, well length). For example an operational attribute can characterize a treatment operation for a wellbore 104 penetrating at least a portion of a subterranean formation 102. In certain embodiments, the one or more operational attributes can include real-time measurements. For example, real-time measurements can include pressure measurements, flow rate measurements, and fluid temperature. In certain embodiments, real-time measurements can be obtained from one or more wellsite data sources. Wellsite data sources can include, but are not limited to flow sensors, pressure sensors, thermocouples, and any other suitable measurement apparatus. For example, wellsite data sources can be positioned at the surface, on a downhole tool, in the wellbore 104 or in a fracture 116. Pressure measurements can, for example, be obtained from a pressure sensor at a surface of the wellbore 104.

Values of the operational attributes can be used by a RNN to determine values for one or more controllable wellbore treatment attributes. In certain embodiments, one or more controllable wellbore treatment attributes can include, but are not limited to an amount of treatment fluid pumped into the wellbore system 100, the wellbore pressure at the injection points 114, the flow rate at the wellbore inlet 110, the pressure at the wellbore inlet 110, an acid flow rate, a proppant flow rate, a proppant concentration, a selected distance between perforation clusters, a proppant particle diameter, and any combination thereof.

In certain embodiments, the pressure at the wellbore inlet 110 predicted by a RNN can be used, at least in part, to determine whether to use a proppant, to determine how much proppant to use, to develop a stimulation pumping schedule, or any combination thereof. For example, in certain embodiments, flow rates and/or pressure sensors can be positioned at the wellbore inlet 110 of the wellbore 104 to measure the flow rate and pressure in real time. The measured inlet flow rate and pressure data can be used as operational attributes. In some embodiments, the one or more formation attributes can characterize the subterranean formation 102. In certain embodiments, the one or more formation attributes can include properties of the subterranean formation 102 such as the geometry of the subterranean formation 102, the stress field, pore pressure, formation temperature, porosity, resistivity, water saturation, hydrocarbon composition, and any combination thereof

### Example Recurrent Neural Networks and Recurrent Neural Network Systems

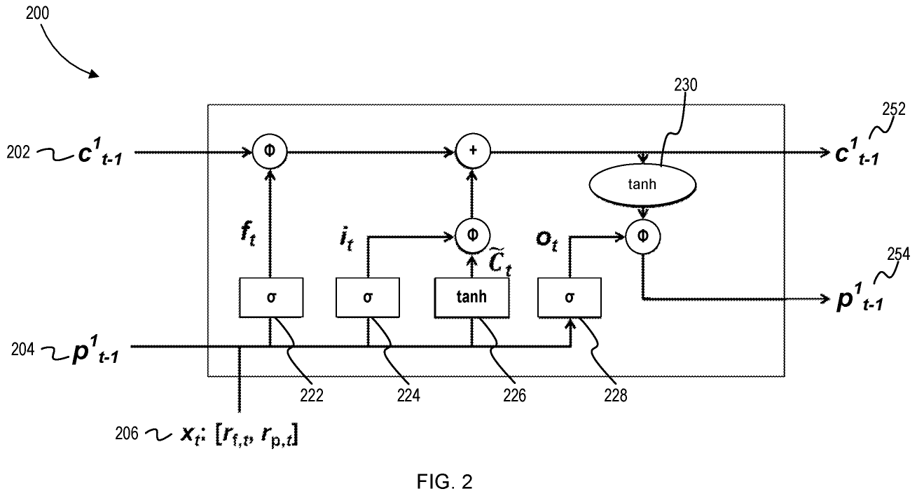

FIG. 2 depicts a schematic of a Long Short-Term Memory (LSTM) cell, according to some embodiments. The LSTM cell 200 can be part of a RNN. The LSTM cell 200 at timestep t can receive and store various information. One type of information storable by the LSTM cell 200 is the cell state C¹ₜ₋₁ 202, which is the cell state of the LSTM cell determined at the previous timestep t−1. In some embodiments, a timestep is a simulated representation of actual time. Alternatively, a timestep can be an arbitrary unit that represents different stages of operations, such as a stage during a well treatment operation.

A type of information receivable by the LSTM cell 200 is the output p¹ₜ₋₁ 204, which is the output determined at the previous timestep t−1. Another type of information receivable by the LSTM cell 200 is the input xₜ 206, which can be a uni- or multivariate input at the current timestep t. The input xₜ 206 can include operational attributes such as a fluid rate r_{f,t} and/or a proppant rate r_{p,t} from timestep t within the predefined look-up window of the LSTM cell 200, which can be expressed as shown in Equation 1.

xₜ=[r_{f,t},r_{p,t]} (1)

In some embodiments, the input xₜ 206 can include other operational attributes, and can be determined before starting the treatment based upon the treatment design. Examples of such inputs can include proppant properties, fluid properties, surface pressure, borehole diameter, temperature, acid concentration, etc.

The LSTM cell can use four gates to process information, each of which can have weights and biases associated with them. These weights and biases can be calibrated during a training process to provide accurate predictions of an output in a time series. In some embodiments, the forget gate 222 can be used to determine an intermediary set of forget gate values fₜ. The forget gate 222 can be modeled as shown in Equation 2 below, where σ is a sigmoid function, pₜ₋₁ is an output of the LSTM cell 200 from the previous timestep t−1, W_{f} is a weight associated with the forget gate, and b_{f} is a bias of the forget gate.

fₜ=σ(W_{f}·[pₜ₋₁,xₜ]+b_{f}) (2)

The input gate 224 can be used to determine an intermediary set of input values iₜ. The input gate 224 can be modeled as show n in Equation 3 below, where Wₜ is a weight associated with the input gate iₜ 224 and b_{f} is a bias of the input gate iₜ 224.

iₜ=σ(Wᵢ·[pₜ₋₁,xₜ]+b_{f}) (3)

In addition to the forget gate and input gate, a candidate gate 226 can be used to generate a candidate cell state values Čₜ. In some embodiments, the candidate gate can be modeled as shown in Equation 4 below, wherein W_{c} is a weight associated with the candidate gate and b_{c} is a bias associated with the candidate gate.

Čₜ=tan h(W_{c}[pₜ₋₁,xₜ]+b_{c}) (4)

Once the values from the forget gate 222, input gate 224, and candidate gate 226 have been determined, the cell state values Cₜ at the current timestep t can be determined based on the previous cell state values, forget gate results, and input gate results. For example, the cell state C¹ₜ 254 can be determined based on the cell state C¹ₜ₋₁ 202 from a previous timestep, the candidate cell state values, the values from the forget gate 222 calculated using Equation 2, the values from the candidate gate 226 calculated from Equation 3, and the candidate cell state values Čₜ. This determination can be modeled as shown in Equation 5 below, wherein ⊙ represents the element-wise product operator:

Cₜ¹=fₜ⊙Cₜ₋₁¹+iₜ⊙Čₜ (5)

The output gate 228 can be used to determine a set of intermediary output values oₜ based on the set of input values xₜ. In some embodiments, a sigmoid function can be applied onto a result based on the set of input values xₜ and the previous cell output pₜ₋₁ 204. This determination can be modeled as shown in Equation 6 below, wherein oₜ is the set of intermediary output gate values, Wₒ is a weight associated with the output gate and bₒ is a bias of the output gate:

oₜ=σ(Wₒ·[pₜ₋₁,xₜ]+bₒ) (6)

The final output gate 230 can be used to determine the output p¹ₜ 254 based on the result of the output gate oₜ to keep it in a particular range as a function of the cell state. In some embodiments, the final output gate 230 can be modeled as shown in Equation 7.

pₜ=oₜ⊙ tan h(Cₜ) (7)

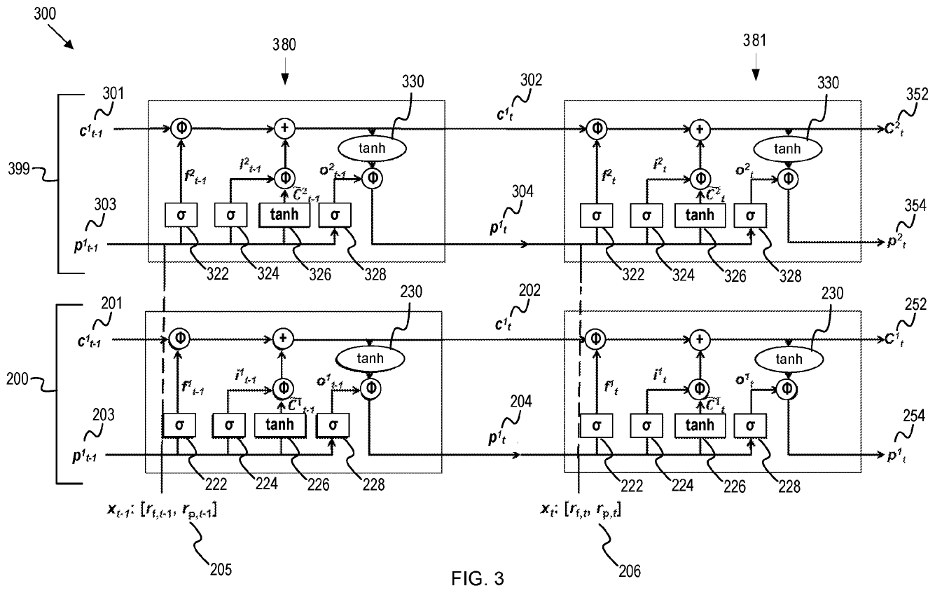

FIG. 3 depicts a schematic of stacked LSTM cells in a neural network, according to some embodiments. The stacked LSTM cells 300 includes the LSTM cell 200 and the LSTM cell 399 operating at a first timestep t−1 and a second timestep t. The two cells operating at the first timestep t−1 is shown in the first column and the two cells operating at the second timestep t is shown in the second column 381.

At timestep t−1, the LSTM cell 200 can determine a cell state C¹ₜ₋₁ 202 (its cell state from timestep t−1) and output p¹ₜ₋₁ 204 (the output from the LSTM cell 200 at timestep t−1) based on cell state C¹ₜ₋₂ 201 (the cell state from the LSTM cell 200 at timestep t−2), the output p¹ₜ₋₂ 203 (the output from the LSTM cell 200 at timestep t−2), and the multivariate input xₜ₋₁ 205 (the multivariate input at timestep t−1). With reference to FIG. 2, the LSTM cell 200 can use the same operations as described above for the forget gate 222, input gate 224, candidate gate 226, output gate 228, normalized output gate 230, and Equations 2-7 to determine the cell state C¹ₜ₋₁ 202 and output p¹ₜ₋₁ 204.

In some embodiments, a LSTM cell 399 can operate concurrently with the LSTM cell 200. At timestep t−1, the LSTM cell 399 can determine a cell state (C¹ₜ₋₁ 302 (its cell state from timestep t−1) and output p¹ₜ₋₁ 204 (the output from the LSTM cell 399 at timestep t−1) based on its cell state C²ₜ₋₂ 301 (cell state from the LSTM cell 399 at timestep t−2), the output pₜ₋₁ 304 (the output from the LSTM cell 399 at timestep t−2), and the multivariate input xₜ 206 (the multivariate input at the timestep t−1). With reference to FIG. 2, the forget gate 322, input gate 324, candidate gate 326, output gate 328, and gate 330 can operate in the same or similar operations as that of the forget gate 222, input gate 224, candidate gate 226, output gate 228, and normalized output gate 230, respectively. The LSTM cell 399 can use these operations to determine the cell state Cₜ₋₁ 302 and output pₜ₋₁ 304.

In some embodiments, at timestep t, the LSTM cell 200 can determine its cell state C¹ₜ 252 and output p¹ₜ 254 at timestep t based on its cell state C¹ₜ₋₁ 202, the output p¹ₜ₋₁ 204, and the multivariate input xₜ 206 at timestep t. The LSTM cell 200 can determine its cell state C¹ₜ 252 and output p¹ₜ 254 at timestep t using the same or similar operations as described above for the LSTM cell 200 at timestep t−1.

In some embodiments, at timestep t, the LSTM cell 399 can determine its cell state Cₜ 352 and output p²ₜ 354 at timestep t based on its cell state C²ₜ₋₁ 302, output p²ₜ₋₁ 304, and the multivariate input xₜ 306 at the timestep t. At timestep t, the LSTM cell 399 can use the same or similar operations as described above for the LSTM cell 399) at timestep t−1 to determine the cell state Cₜ 352 and output p²ₜ 354.

### Example RNN Operations

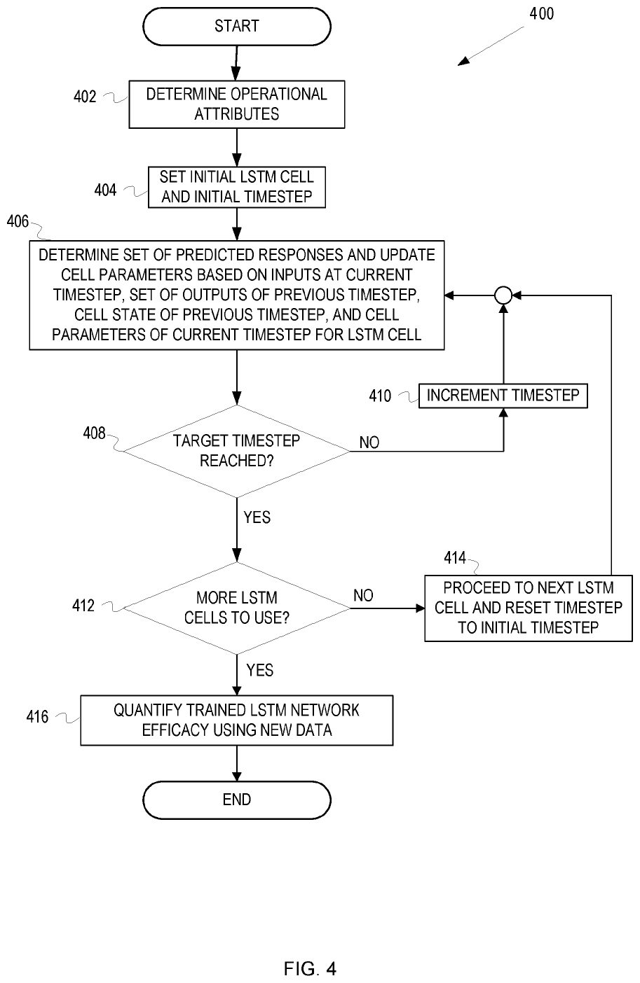

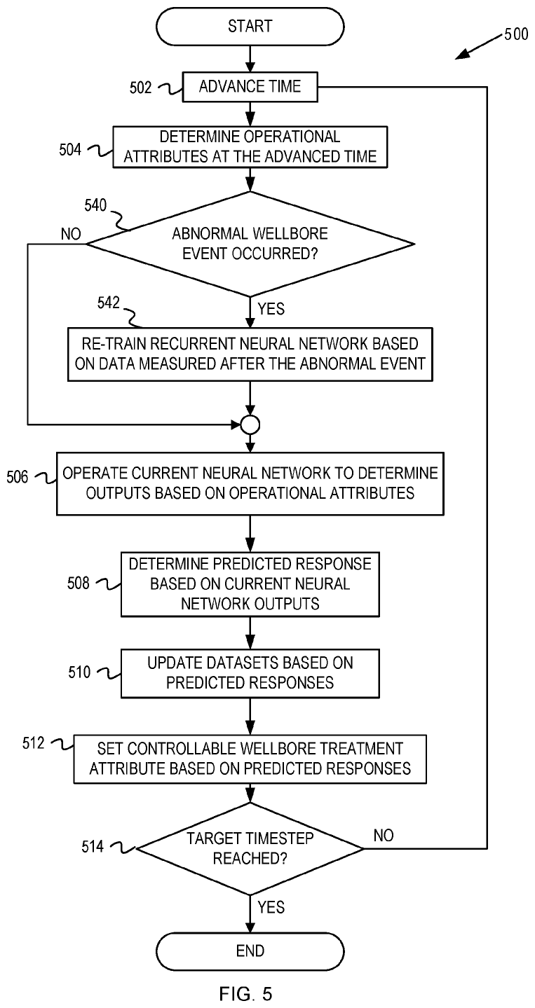

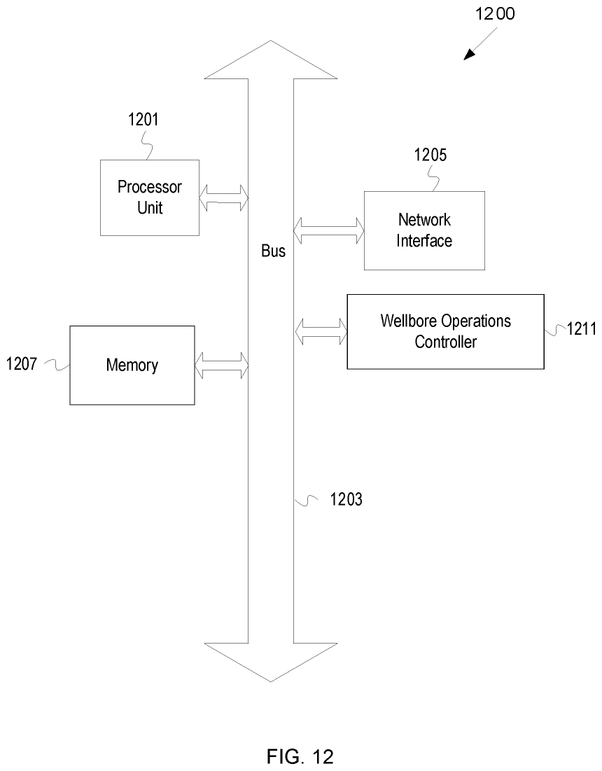

FIG. 4 and FIG. 5 depict flowcharts of operations that can be performed by software, firmware, hardware or a combination thereof. For example, with reference to FIG. 12 (further described below), a processor in a computer device located at the surface can execute instructions to perform operations of the flowchart 400.

FIG. 4 depicts a flowchart of operations to train stacked LSTM cells, according to some embodiments. Operations of the flowchart 400 begin at block 402. At block 402, a set of operational attributes at a first measurement time is determined. For example, a set of operational attributes can include a fluid rate in units of barrels per minute (BPM) and a proppant rate also in units of BPM. An example dataset for a set of timesteps recording these operational attributes can be shown in Table 1, along with a surface pressure with units of pounds per square inch (psi).

TABLE 1

| | Fluid Rate | Proppant | Surface |
|---|---|---|---|
| Timestep | (BPM) | Rate (BPM) | Pressure (psi) |
| 1 | 7.81 | 81.30 | 8500.5 |
| 2 | 7.87 | 81.23 | 8501.3 |
| 3 | 7.90 | 81.21 | 8495.9 |
| 4 | 7.90 | 81.21 | 8499.1 |
| 5 | 7.87 | 80.95 | 8498.3 |

At block 404, an initial LSTM cell and an initial timestep t is set. The initial LSTM cell can be set to a cell in an RNN system. For example, with reference to FIG. 3, in the case of operating the operations of flowchart 400 using the stacked LSTM cells 300, the initial LSTM cell can be set to the LSTM cell 200. The initial timestep can be the first timestep at which input data is available, a pre-determined number of timesteps before a target timestep, or an event-based initial timestep. For example, with reference to Table 1, the initial timestep can be set to timestep 1. Alternatively, if the target timestep is timestep 4, the initial timestep can be set to two timesteps before the target timestep, which would result in the initial timestep being set to timestep 2. Alternatively, the initial timestep can be event-based and set to the first timestep after which an event such as a fracture reaching a fault occurs.

At block 406, a set of predicted responses are determined and the cell parameters are updated based on operational attributes at the current timestep, the output from a previous timestep, the cell state of the previous timestep, and the set of cell parameters for a LSTM cell. In some embodiments, the set of cell parameters can include the cell states, weights and biases of each gate (e.g. Cₜ, W_{f}, b_{f}, Wᵢ, bᵢ, W_{c}, b_{c}, Wₒ, bₒ, etc.) and other parameters of a neural network cell. The set of outputs for the current timestep can be determined using the LSTM cell 399 based on Equations 1-7. In some embodiments, the set of cell parameters can be updated based on the difference between a predicted response and a measured response.

For example, with reference to Table 1, a set of operational attributes can include the fluid rate and proppant rate corresponding with timestep 3. With further reference to FIG. 3, the LSTM cell 399 can be used to predict a surface pressure of 8401.5 psi based on the fluid rate of 7.90 BPM, the proppant rate of 81.21 BPM, the cell state Cᵢ of the LSTM cell 399, and the set of cell parameters. In some embodiments, this prediction can be compared to the actual surface pressure measurement 8499.1 to determine a prediction error. The prediction error can be used to update the value of the set of cell parameters. For example, the set of cell parameters used to determine the predicted value of 8401.5 psi could have been 0.75, 0.55, 0.57, 0.54, 0.46, 0.3, 0.76, and 0.9 for W_{f}, b_{f}, Wᵢ, bᵢ, W_{c}, bᵢ, b_{c}, Wₒ, and bₒ, respectively. After updating the cell parameters using a backpropagation method, the next cell parameters can be 0.65, 0.95, 0.50, (0.53, 0.16, 0.2, 0.76, and 0.95, respectively.

At block 408, a determination is made of whether a target timestep is reached. In some embodiments, a target timestep can be manually set. For example, the target timestep can be set to 10. Alternatively, a target timestep can be set to the total number of available timesteps. For example, when training a RNN to calibrate its cell parameters with 20 recorded timesteps, the target timestep can be set to 20 If the target timestep is reached, then operations of the flowchart 400 continue at block 412. If the target timestep is not reached, then operations of the flowchart 400 continue at block 410.

At block 410, the timestep is incremented. Once the timestep is incremented, the operations of the flowchart 400 continue at block 406, wherein an output for the incremented timestep can be determined. In addition, the set of cell parameters can be updated based on the inputs of the incremented timestep, the set of outputs from the previous timestep, and the cell state of the previous timestep, as previously disclosed.

At block 412, a determination is made of whether more LSTM cells are to be used. In some embodiments, more LSTM cells are to be used if at least one allocated LSTM cell has not been trained and/or used to determine the set of outputs. In some embodiments, the number of allocated LSTM cells can be pre-determined or manually set before the start of the operations of the flowchart 400. For example, with respect to FIG. 3, the number of allocated LSTM cells can be set to 2. In some embodiments, the number of allocated LSTM cells can be dynamically determined based on the set of outputs at a previous timestep. If more LSTM cells are to be used, the operations of the flowchart 400 continue at block 416. Otherwise, the operations of the flowchart 400 continue at block 416.

At block 414, the operation proceeds to the next LSTM cell and resets the timestep r to the initial timestep. In some embodiments, it can be determined that at least one more available LSTM cell has not been used and that a LSTM cell is selected as the next LSTM cell. For example, with reference to FIG. 3, after using the LSTM cell 200, the LSTM cell 399 can be selected as the next LSTM cell.

At block 416, the efficacy of the LSTM neural network is quantified using unused data. In some embodiments, the efficacy of the LSTM neural network can be quantified based on the accuracy, precision, and speed of calculation using datasets that were not used to train or validate the LSTM neural network. Based on the LSTM neural network efficacy, a decision can be made of whether or not to use the trained LSTM neural network during wellbore operations. Once the efficacy of the LSTM network is quantified, operations of the flowchart 400 are complete.

FIG. 5 depicts a flowchart of operations for predicting values using a recurrent neural network (RNN) of based on operational attributes of a wellbore, according to some embodiments. Operations of the flowchart 500 begin at block 502.

At block 502, a timestep is advanced. In some embodiments, a timestep can be a unitless stage of operation. For example, advancing from a first timestep to a second timestep could represent advancing from a first stage of operation to a second stage of operation. In some embodiments, a timestep can be a constant time interval. For example, the time between each of a set of timesteps could be 6 hours. Alternatively, a timestep can be a variable timestep. For example, the length of a variable timestep can be 1 minute if a predicted response is less than 10 psi/min or 30 minutes otherwise.

At block 504, operational attributes are determined at the advanced time. In some embodiments, the operational attributes can be determined using one or more operations that are the same as or similar to the operations described above at block 402 of FIG. 4.

At block 540, a determination is made of whether an abnormal wellbore event has occurred. An abnormal wellbore event is an event related to a significant change in the formation or wellbore operation wherein a recurrent neural network trained on measurements taken before the abnormal wellbore event will be less accurate than a recurrent neural network trained on data that discards measurements taken before the abnormal wellbore event. In some embodiments, the determination of whether an abnormal wellbore event has occurred can be based on a measured operational attribute exceeding an event threshold, wherein exceeding an event threshold can include either an operational attribute being greater than or equal to a threshold value or less than or equal to a threshold value. For example, an expected increase in a pressure response can be greater than a threshold value and an abnormal wellbore event titled “large fault encountered” can be set. If an abnormal wellbore event has not occurred, the operations of the flowchart 500 continue at block 506. Otherwise, the operations of the flowchart 400 continue at block 542.

At block 542, the recurrent neural network is re-trained based on data measured after the abnormal wellbore event. The recurrent neural network can be re-trained using one or more operations that are the same as or similar to the operations described above at block 404 to 416 of FIG. 4.

At block 506, a RNN is operated based on the determined operational attributes. In some embodiments, the LSTM cells of the RNN can be operated using one or more operations that are the same as or similar to the operations described above at block 406 of FIG. 4. In some embodiments, each cell of a neural network can be operated in parallel for each timestep. For example, with further reference to FIG. 2, each cell of a neural network can be operated as described above for the gates 222-230 and Equations 1-7 in parallel to determine the outputs of the cells of the neural network after a timestep. A combine output of the LSTM neural network for the timestep can be based on the outputs of each cell at that timestep.

At block 508, a response is predicted based on the outputs of the RNN. In some embodiments, the response can be based on a mean average of the outputs of each of the LSTM cells multiplied by a normalizing factor. For example, the operations of flowchart 500) could use a total of two cells, wherein the mean average of a first cell and a second cell can be 0.60, and the normalizing factor can be 10 psi. This can result in a LSTM network response of 6.0 psi.

At block 510, datasets are updated based on the predicted responses. In some embodiments, the datasets include the operational attributes and predicted responses. Updating the datasets can include inserting the predicted responses into the datasets. For example a dataset can include known fluid rate and proppant rate at timestep 10. A surface pressure of 100 psi can be predicted based on the known fluid rate and proppant.

At block 512, a controllable wellbore treatment attribute is set based on the predicted responses. In some embodiments, the controllable wellbore treatment attribute can be a flow rate. For example, the LSTM neural network can predict that a treatment fluid flow rate for an optimal pressure at a wellbore can be 1500 BPM. A computer device can then set a surface pump to pump treatment fluid into the wellbore at 1500 BPM.

At block 514, a determination is made of whether a target timestep is reached. In some embodiments, the target timestep can be a timestep that is greater than the number of available timesteps with data. For example, with reference to Table 1, the number of available timesteps is 5 and a target timestep can be 6. Alternatively, a target timestep can dependent on a predicted response or operational attribute. For example, a target timestep be considered as reached if the pressure is greater than 19000 psi and not reached otherwise. If the target timestep is not reached, then operations of the flowchart 500 can continue at block 502. If the target timestep is reached, operations of the flowchart 500 are complete.

### Example Data

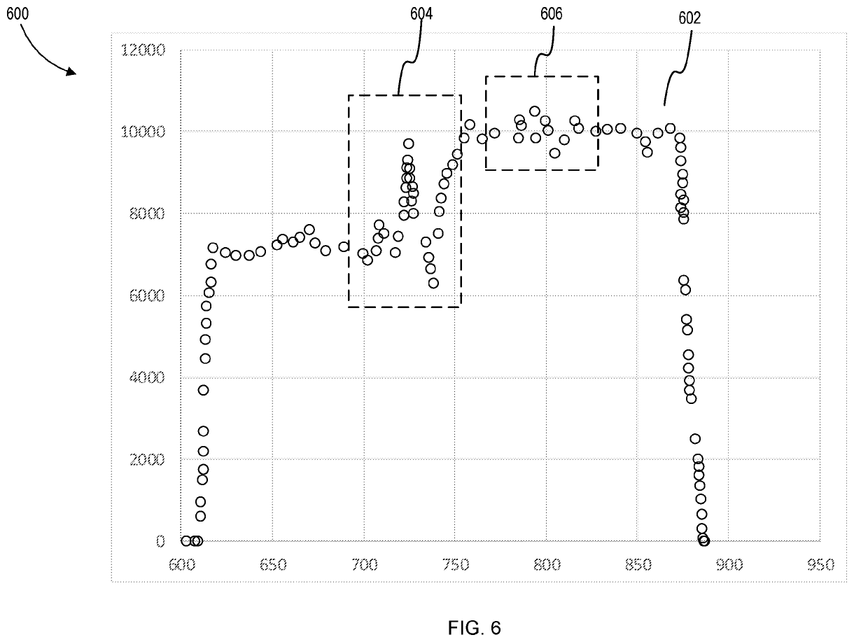

FIG. 6 depicts an example graph of surface pressure vs. time, according to some embodiments. The plot 600 includes an x-axis, a y-axis, a set of pressure data points 602, a first region 604, and a second region 606. The x-axis represents the time since the start of measurements, measured in minutes. The y-axis represents a measured treatment pressure in the units “psi.” The set of pressure data points 602 represents the measured treatment pressure at various measurement times. The first region 604 depicts a non-linearity in the pressure response. The second region 606 depicts a second non-linearity in the pressure response. A non-linearity in a response can be any non-linear trend in a set of data between a first variable and a second variable. A non-linearity in the pressure response can be a result of an operational attribute change (e.g., sudden increase/decrease in flow rate, introduction or reduction of proppant) or a result of encountering a natural discontinuity (e.g., a fracture encountering a fault, the pressure reaching a critical fracturing stress).

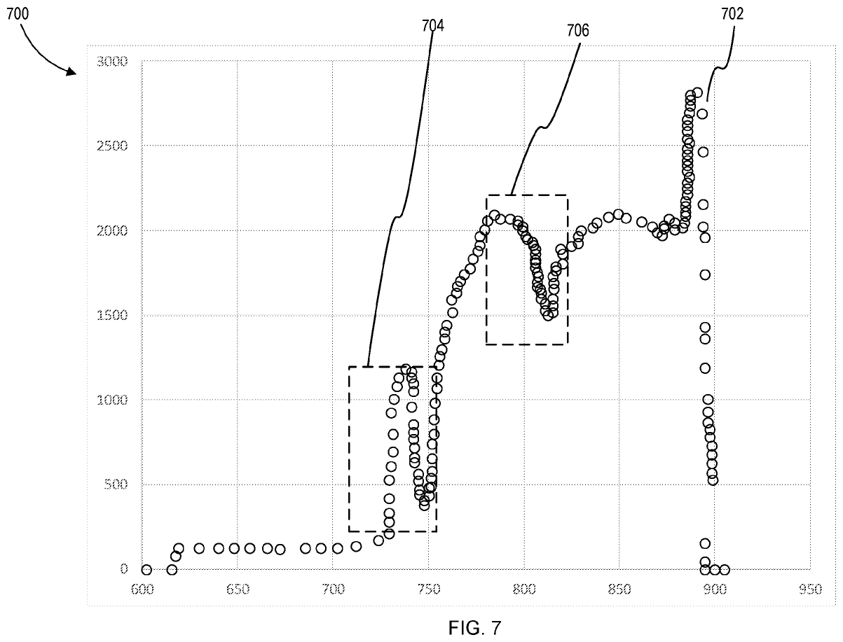

FIG. 7 depicts an example graph of fluid rate vs. time, according to some embodiments. A plot 700 includes an x-axis, a-axis, a set of data points 702, a first region 704, and a second region 706. The x-axis represents the time since the start of measurements, measured in minutes. The y-axis represents a flow rate in the units “cubic feet per minute” The set of data points 702 represents the measured flow rate. With respect to FIG. 6, the first region 704 depicts a non-linearity in the pressure response that corresponds in time with the first region 604, and a comparison of both regions demonstrate a nonlinearity represented by a drop in the pressure and flow rate, respectively. With respect to FIG. 6, the second region 706 also depicts a significant non-linearity in the pressure response that corresponds in time with the second region 606. Unlike in the first region, however, the drop in the flow rate depicted by the second region 706 does not correspond with a significant drop in pressure as shown in the second region 606, demonstrating that significant drops in flow rate can be independent of drops in a pressure response.

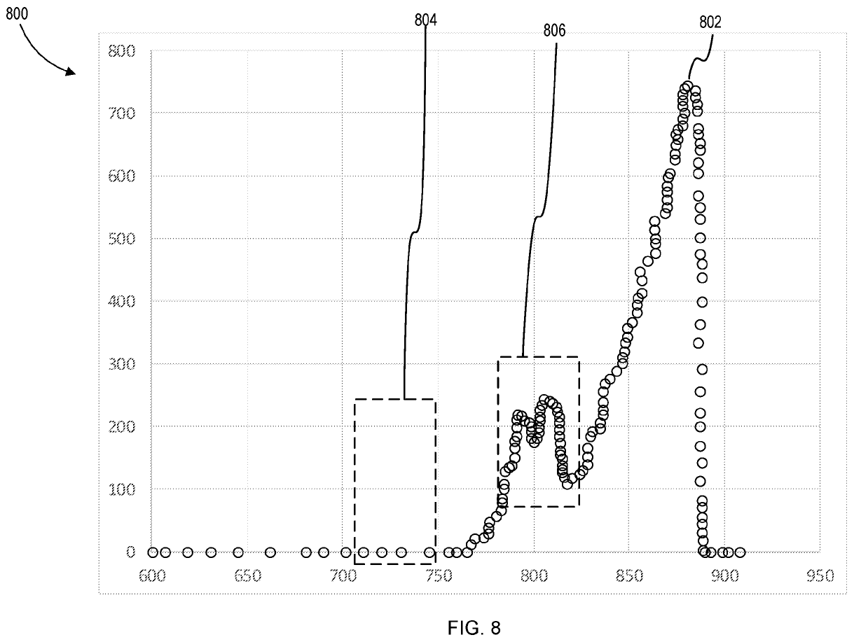

FIG. 8 depicts an example graph of proppant rate vs. time, according to some embodiments. A plot 800 includes an x-axis, a y-axis, a set of data points 802, a first region 804, and a second region 806. The x-axis represents the time since the start of measurements, measured in minutes. The y-axis represents a proppant rate in the units “pounds per minute.” The set of data points 802 represents the measured proppant rate. With respect to FIG. 6, the first region 804 depicts a region with no detected change in the proppant rate measurement that corresponds in time with the first region 604. A comparison of regions 604 and 804 demonstrate that a change in the measured treatment pressure can be independent of any change in the measured proppant rate. With respect to FIG. 6, the second region 806 depicts a significant non-linearity in the proppant rate measurement that corresponds in time with the second region 606. However, the drop in the proppant rate depicted by the second region 806 also does not show a proportional drop in pressure as showing in the second region 606.

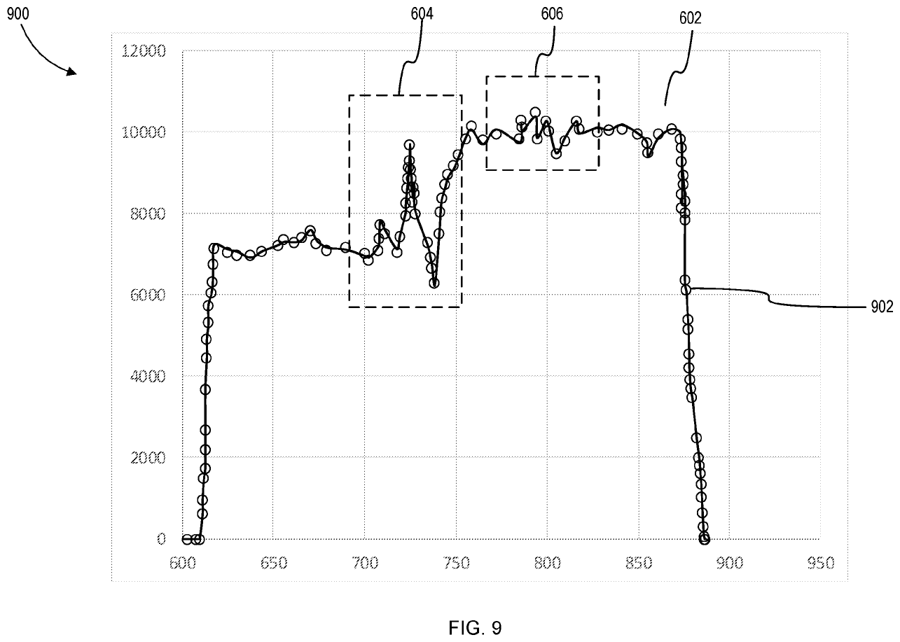

FIG. 9 depicts an example graph of a predicted surface pressure compared to a surface pressure vs. time graph, according to some embodiments. The plot 900 includes an x-axis, a y-axis, the set of pressure data points 602, the first region 604, the second region 606, and a predicted pressure line 902. Each of the set of pressure data points 602, the first region 604, and the second region 606 can represent the same information as depicted in FIG. 6. The predicted pressure line 902 includes responses predicted by the RNN disclosed above. In some embodiments, the values determined by the RNN can be based on the measured flow rate depicted in FIG. 7 and the proppant rate depicted in FIG. 8.

In some embodiments, the RNN system can be trained on data similar to or different from the values depicted in FIG. 7 and FIG. 8. For example, the RNN system used to generate the predicted pressure line 902 can be trained using a plurality of datasets including time, treatment pressure, flow rate and proppant rate measurements, none of which are identical to the data depicted in FIGS. 6-8. Once trained, this trained RNN can generate the predicted pressure line 902 based on the data depicted in FIG. 7 and FIG. 8.

The flowcharts described above are provided to aid in understanding the illustrations and are not to be used to limit scope of the claims. The flowcharts depict example operations that can vary within the scope of the claims. Additional operations can be performed; fewer operations can be performed; the operations can be performed in parallel; and the operations can be performed in a different order. For example, the operations depicted in blocks 406 for each LSTM Cell can be performed in parallel or concurrently. With respect to FIG. 50, updating the dataset is not necessary. It will be understood that each block of the flowchart illustrations and/or block diagrams, and combinations of blocks in the flowchart illustrations and/or block diagrams, can be implemented by program code. The program code can be provided to a processor of a general purpose computer, special purpose computer, or other programmable machine or apparatus.

### Example Well Operations

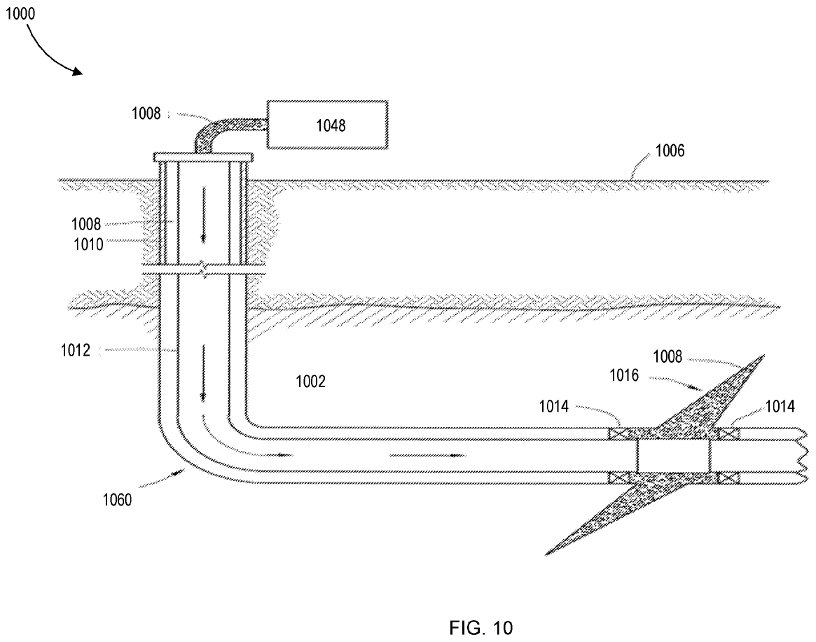

FIG. 10 depicts an example treatment operation being performed in a subterranean formation, according to some embodiments. FIG. 10 depicts a well 1060 during a treatment operation in a portion of a subterranean formation 1002 surrounding a wellbore 1004. The wellbore 1004 extends from a surface 1006, and a treatment fluid 1008 is applied to a portion of the subterranean formation 1002 surrounding the horizontal portion of the wellbore 1004. Although shown as vertical deviating to horizontal, the wellbore 1004 can include horizontal, vertical, slant, curved, and other types of wellbore geometries and orientations, and the treatment operation can be applied to a subterranean zone surrounding any portion of the wellbore 1004. The wellbore 1004 can include a casing 1010 that is cemented or otherwise secured to the wellbore wall. The wellbore 1004 can be uncased or include uncased sections. Perforations can be formed in the casing 1010 to allow treatment fluids and/or other materials (e.g., a proppant, acid, diverter, etc.) to flow into the subterranean formation 1002. In cased wells, perforations can be formed using shape charges, a perforating gun, hydro-jetting and/or other tools.

The well 1060 is shown with a work string 1012 depending from the surface 1006 into the wellbore 1004. The pump and blender system 1048 can be coupled to the work string 1012 to pump the treatment fluid 1008 into the wellbore 1004 and be in communication with a computer device. The work string 1012 can include coiled tubing, jointed pipe, and/or other structures that allow fluid to flow into the wellbore 1004. The work string 1012 can include flow control devices, bypass valves, ports, and or other tools or well devices that control a flow of fluid from the interior of the work string 1012 into the subterranean formation 1002. For example, the work string 1012 can include ports adjacent the wellbore wall to communicate the treatment fluid 1008 directly into the subterranean formation 1002, and/or the work string 1012 can include ports that are spaced apart from the wellbore wall to communicate the treatment fluid 1008 into an annulus in the wellbore between the work string 1012 and the wellbore wall.

The work string 1012 and/or the wellbore 1004 can include one or more sets of packers 1014 that seal the annulus between the work string 1012 and wellbore 1004 to define an interval of the wellbore 1004 into which the treatment fluid 1008 will be pumped. FIG. 10 shows the packers 1014, one defining an uphole boundary of the interval and one defining the downhole end of the interval. When the treatment fluid 1008 is introduced into wellbore 1004 (e.g., the area of the wellbore 1004 between packers 1014) at a sufficient hydraulic pressure, one or more fractures 1016 can be created in the subterranean formation 1002.

In some embodiments, the treatment fluid 1008 can include proppant particles. For example, treatment fluid 1008 can contain proppant particles that can enter the fractures 1016 as shown, or can plug or seal off fractures 1016 to reduce or prevent the flow of additional fluid into those areas. A controllable wellbore treatment attribute such as the proppant rate can be set, wherein the proppant rate to be set is based on the result of the RNN operations disclosed above. The RNN operations can be used to predict a pressure change, and controllable wellbore treatment attributes can be changed in response to the predicted pressure change. For example, the RNN operation can predict an increase in the treatment pressure from 10000 psi to 15000 psi based on an existing set of operational attributes, which can be above a pressure threshold. In response, a proppant rate can be reduced to reduce the predicted and measured treatment pressure. Alternatively, the RNN operation can predict an optimal controllable wellbore treatment attribute directly. For example, the RNN operation can predict an optimal proppant rate of 5000 BPM and a computer device can set the proppant rate to 5000 BPM in response to the prediction.

In some embodiments, the treatment fluid 1008 can include an acid and be pumped into the subterranean formation 1002. For example, the treatment fluid 1008 can include hydrogen fluoride and create wormholes in a portion of the subterranean formation 1002. A controllable wellbore treatment attribute such as the acid concentration to be used can be based on the result of the RNN operations disclosed above. The RNN operations can be used to predict a wormhole growth rate, and controllable wellbore treatment attributes can be changed in response to the predicted pressure change. For example, the RNN operation can predict a decrease in wormhole length based on an existing set of operational attributes. In response, a flow rate can be reduced to reduce the predicted and measured treatment pressure.

In some embodiments, the treatment fluid 1008 can include a diverter and/or a bridging agent to plug or partially plug a zone of a well by forming a bridge. For example, the diverter can plug a first zone and treatment fluid can be diverted by the bridge to a less permeable zone. A controllable wellbore treatment attribute such as the diverter concentration to be used can be based on the result of the RNN operations disclosed above. The RNN operations can be used to predict a maximum stress that a diverter can withstand, and controllable wellbore treatment attributes can be changed in response to the predicted maximum stress. For example, the RNN operation can predict a reduced maximum stress based on an existing set of operational attributes. In response, a diverter concentration can be increased to increase the predicted maximum stress.

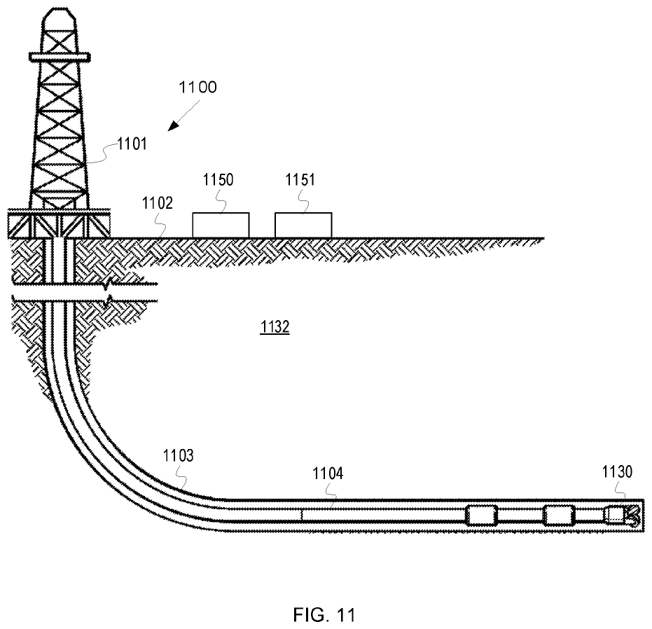

FIG. 11 depicts an example drilling operation being performed in a subterranean formation, according to some embodiments FIG. 11 depicts a drilling system 1100. The drilling system 1100 includes a drilling rig 1101 located at the surface 1102 of a borehole 1103. The drilling system 1100 also includes a pump 1150 that can be operated to pump fluid through a drill string 1104. The drill string 1104 can be operated for drilling the borehole 1103 through the subsurface formation 1132 with the BHA

The BHA includes a drill bit 1130 at the downhole end of the drill string 1104. The BHA and the drill bit 1130 can be coupled to computing system 1151, which can operate the drill bit 1130 and the pump 1150. The drill bit 1130 can be operated to create the borehole 1103 by penetrating the surface 1102 and subsurface formation 1132. In some embodiments, a controllable wellbore treatment attribute such as the drilling RPM or a drilling fluid flow rate can be based on the result of the RNN operations disclosed above. The RNN operations can be used to predict a drilling speed, and controllable wellbore treatment attributes can be changed in response to the predicted drilling speed. For example, the RNN operation can predict a drilling speed of (0.5 feet/minute based on an existing set of operational attributes and that this drilling speed can be increased by increasing a mud flow rate. In response, the computing system 1151 can operate the pump 1150 to increase the mud flow rate to increase the drilling speed.

### Example Computer Device

FIG. 12 depicts an example computer device, according to some embodiments. A computer device 1200 includes a processor 1201 (possibly including multiple processors, multiple cores, multiple nodes, and/or implementing multi-threading, etc.). The computer device 1200 includes a memory 1207. The memory 1207 can be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer device 1200 also includes a bus 1203 (e.g., PCI, ISA, PCI-Express, HyperTransport® bus, InfiniBand® bus, NuBus, etc.) and a network interface 1205 (e.g., a Fiber Channel interface, an Ethernet interface, an internet small computer system interface, SONET interface, wireless interface, etc.).

The computer device 1200 includes a wellbore operations controller 1211. The wellbore operations controller 1211 can perform one or more wellbore control operations described above. For example, the wellbore operations controller 1211 can set a controllable wellbore treatment attribute based on the predicted responses of a RNN. Additionally, the wellbore treatment controller 1211 can control one or more wellbore operation of a treatment operation or drilling operation based on the value of the controllable wellbore treatment attribute.

Any one of the previously described functionalities can be partially (or entirely) implemented in hardware and/or on the processor 1201. For example, the functionality can be implemented with an application specific integrated circuit, in logic implemented in the processor 1201, in a co-processor on a peripheral device or card, etc. Further, realizations can include fewer or additional components not illustrated in FIG. 12 (e.g., video cards, audio cards, additional network interfaces, peripheral devices, etc.). The processor 1201 and the network interface 1205 are coupled to the bus 1203. Although illustrated as being coupled to the bus 1203, the memory 1207 can be coupled to the processor 1201. The computer device 1200 can be device at the surface and/or integrated into component(s) in the wellbore.

As will be appreciated, aspects of the disclosure can be embodied as a system, method or program code/instructions stored in one or more machine-readable media. Accordingly, aspects can take the form of hardware, software (including firmware, resident software, micro-code, etc.), or a combination of soft are and hardware aspects that can all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) can be utilized. The machine-readable medium can be a machine-readable signal medium or a machine-readable storage medium. A machine-readable storage medium can be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory, a portable compact disc read-only memory (CD-ROM), an optical storage device, a magnetic storage device, or any suitable combination of the foregoing. In the context of this document, a machine-readable storage medium can be any tangible medium that can contain, or store a program for use by or in connection with an instruction execution system, apparatus, or device. A machine-readable storage medium is not a machine-readable signal medium.

A machine-readable signal medium can include a propagated data signal with machine readable program code embodied therein, for example, in baseband or as part of a carrier wave. Such a propagated signal can take any of a variety of forms, including, but not limited to, electro-magnetic, optical, or any suitable combination thereof. A machine-readable signal medium can be any machine readable medium that is not a machine-readable storage medium and that can communicate, propagate, or transport a program for use by or in connection with an instruction execution system, apparatus, or device.

Program code embodied on a machine-readable medium can be transmitted using any appropriate medium, including but not limited to wireless, wireline, optical fiber cable, RF, etc., or any suitable combination of the foregoing.

Computer program code for carrying out operations for aspects of the disclosure can be written in an combination of one or more programming languages, including an object oriented programming language such as the Java, programming language, C++ or the like; a dynamic programming language such as Python; a scripting language such as Perl programming language or PowerShell script language; and conventional procedural programming languages, such as the “C” programming language or similar programming languages. The program code can execute entirely on a stand-alone machine, can execute in a distributed manner across multiple machines, and can execute on one machine while providing results and or accepting input on another machine.

The program code/instructions can also be stored in a machine-readable medium that can direct a machine to function in a particular manner, such that the instructions stored in the machine-readable medium produce an article of manufacture including instructions which implement the function/act specified in the flowchart and/or block diagram block or blocks.

### Variations

Plural instances can be provided for components, operations or structures described herein as a single instance. Finally, boundaries between various components, operations and data stores are somewhat arbitrary, and particular operations are illustrated in the context of specific illustrative configurations. Other allocations of functionality are envisioned and can fall within the scope of the disclosure. In general, structures and functionality presented as separate components in the example configurations can be implemented as a combined structure or component. Similarly, structures and functionality presented as a single component can be implemented as separate components. These and other variations, modifications, additions, and improvements can fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### EXAMPLE EMBODIMENTS

Example embodiments include the following;

### Embodiment 1

A method comprising: performing a first wellbore treatment operation of a wellbore, determining an operational attribute of the well in response to the first wellbore treatment operation; determining a predicted response using a recurrent neural network and based on the operational attribute; and setting a controllable wellbore treatment attribute based on the predicted response; and performing a second wellbore treatment operation of the wellbore based on the controllable wellbore treatment attribute.

### Embodiment 2

The method of Embodiment 1, wherein determining the predicted response comprises resolving a time and space variation of the predicted response.

### Embodiment 3

The method of Embodiments 1 or 2, wherein resolving the time and space variation of the predicted response comprises resolving the time and space variation between the first wellbore treatment operation and the second wellbore treatment operation.

### Embodiment 4

The method of any of Embodiments 1-3, further comprising: training, prior to determining the predicted response, the recurrent neural network based on a first value of the operational attribute, detecting that an abnormal wellbore event has occurred; and in response to detecting the abnormal wellbore event has occurred, retraining the recurrent neural network based on a second value of the operational attribute and not based on the first value of the operational attribute, wherein the second value of the operational attribute is determined based on a measurement made after the abnormal wellbore event.

### Embodiment 5

The method of any of Embodiments 1-4, further comprising determining a formation attribute, wherein determining the predicted response is further based on the formation attribute.

### Embodiment 6

The method of any of Embodiments 1-5, wherein the controllable wellbore treatment attribute comprises at least one of a surface treating pressure, fluid pumping rate, and proppant rate.

### Embodiment 7

The method of any of Embodiments 1-6, wherein the recurrent neural network comprises a long short-term memory cell.

### Embodiment 8

One or more non-transistor machine-readable media comprising program code, the program code to: perform a first wellbore treatment operation of a wellbore; determine an operational attribute of the well in response to the first wellbore treatment operation; determine a predicted response using a recurrent neural network and based on the operational attribute; and set a controllable wellbore treatment attribute based on the predicted response and perform a second wellbore treatment operation of the wellbore based on the controllable wellbore treatment attribute.

### Embodiment 9

The one or more non-transitory machine-readable media of Embodiment 8, wherein the program code to determine the predicted response comprises program code to resolve a time and space variation of the predicted response.

### Embodiment 10

The one or more non-transitory machine-readable media of Embodiments 8 or 9, wherein the program code to resolve the time and space variation of the predicted response comprises program code to resolve the time and space variation between the first wellbore treatment operation and the second wellbore treatment operation.

### Embodiment 11

The one or more non-transitory machine-readable media of any of Embodiments 8-10, wherein the program code further comprises program code to: train, prior to determining the predicted response, the recurrent neural network based on a first value of the operational attribute; detect that an abnormal wellbore event has occurred; and in response to detecting the abnormal wellbore event has occurred, retrain the recurrent neural network based on a second value of the operational attribute and not based on the first value of the operational attribute, wherein the second value of the operational attribute is determined based on a measurement made after the abnormal wellbore event.

### Embodiment 12

The one or more non-transitory machine-readable media of any of Embodiments 8-11, wherein the program code further comprises program code determine a formation attribute, wherein determining the predicted response is further based on the formation attribute.

### Embodiment 13

The one or more non-transitory machine-readable media of any of Embodiments 8-12, wherein the controllable wellbore treatment attribute comprises at least one of a surface treating pressure, fluid pumping rate, and proppant rate.

### Embodiment 14

The one or more non-transitory machine-readable media of any of Embodiments 8-13, wherein the recurrent neural network comprises a long short-term memory cell.

### Embodiment 15

A system comprising: a well pump; a processor; a machine-readable medium having program code executable by the processor to cause the processor to, perform a first wellbore treatment operation of a wellbore; determine an operational attribute of the well in response to the first wellbore treatment operation; determine a predicted response using a recurrent neural network and based on the operational attribute; and set a controllable wellbore treatment attribute based on the predicted response; and perform a second wellbore treatment operation of the wellbore based on the controllable wellbore treatment attribute.

### Embodiment 16

The system of Embodiment 15, wherein the program code executable by the processor to determine the predicted response comprises program code to resolve a time and space variation of the predicted response.

### Embodiment 17

The system of Embodiments 15 or 16, wherein the program code executable by the processor to resolve the time and space variation of the predicted response comprises program code to resolve the time and space variation between the first wellbore treatment operation and the second wellbore treatment operation.

### Embodiment 18

The system of any of Embodiments 15-17, wherein the program code executable by the processor further comprises program code to cause the processor to: train, prior to determining the predicted response, the recurrent neural network based on a first value of the operational attribute; detect that an abnormal wellbore event has occurred; and in response to detecting the abnormal wellbore event has occurred, retrain the recurrent neural network based on a second value of the operational attribute and not based on the first value of the operational attribute, wherein the second value of the operational attribute is determined based on a measurement made after the abnormal wellbore event.

### Embodiment 19

The system of any of Embodiments 15-18, wherein the program code executable by the processor further comprises program code to cause the processor to determine a formation attribute, wherein determining the predicted response is further based on the formation attribute.

### Embodiment 20

The system of any of Embodiments 15-19, wherein the controllable wellbore treatment attribute comprises at least one of a surface treating pressure, fluid pumping rate, and proppant rate.

What is claimed is:

1. A method comprising:
performing a first wellbore treatment operation of a wellbore;
determining an operational attribute of the well in response to the first wellbore treatment operation;
determining a predicted response using a recurrent neural network and based on the operational attribute; and
setting a controllable wellbore treatment attribute based on the predicted response; and
performing a second wellbore treatment operation of the wellbore based on the controllable wellbore treatment attribute.

2. The method of claim 1, wherein determining the predicted response comprises resolving a time and space variation of the predicted response.

3. The method of claim 2, wherein resolving the time and space variation of the predicted response comprises resolving the time and space variation between the first wellbore treatment operation and the second wellbore treatment operation.

4. The method of claim 1, further comprising:
training, prior to determining the predicted response, the recurrent neural network based on a first value of the operational attribute;
detecting that an abnormal wellbore event has occurred; and
in response to detecting the abnormal wellbore event has occurred,
retraining the recurrent neural network based on a second value of the operational attribute and not based on the first value of the operational attribute, wherein the second value of the operational attribute is determined based on a measurement made after the abnormal wellbore event.

5. The method of claim 1, further comprising determining a formation attribute, wherein determining the predicted response is further based on the formation attribute.

6. The method of claim 1, wherein the controllable wellbore treatment attribute comprises at least one of a surface treating pressure, fluid pumping rate, and proppant rate.

7. The method of claim 1, wherein the recurrent neural network comprises a long short-term memory cell.

8. One or more non-transitory machine-readable media comprising program code, the program code to:
perform a first wellbore treatment operation of a wellbore;
determine an operational attribute of the well in response to the first wellbore treatment operation;
determine a predicted response using a recurrent neural network and based on the operational attribute; and
set a controllable wellbore treatment attribute based on the predicted response; and
perform a second wellbore treatment operation of the wellbore based on the controllable wellbore treatment attribute.

9. The one or more non-transitory machine-readable media of claim 8, wherein the program code to determine the predicted response comprises program code to resolve a time and space variation of the predicted response.

10. The one or more non-transitory machine-readable media of claim 9, wherein the program code to resolve the time and space variation of the predicted response comprises program code to resolve the time and space variation between the first wellbore treatment operation and the second wellbore treatment operation.

11. The one or more non-transitory machine-readable media of claim 8, wherein the program code further comprises program code to:
train, prior to determining the predicted response, the recurrent neural network based on a first value of the operational attribute;
detect that an abnormal wellbore event has occurred; and
in response to detecting the abnormal wellbore event has occurred,
retrain the recurrent neural net work based on a second value of the operational attribute and not based on the first value of the operational attribute, wherein the second value of the operational attribute is determined based on a measurement made after the abnormal wellbore event.

12. The one or more non-transitory machine-readable media of claim 8, wherein the program code further comprises program code determine a formation attribute, wherein determining the predicted response is further based on the formation attribute.

13. The one or more non-transitory machine-readable media of claim 8, herein the controllable wellbore treatment attribute comprises at least one of a surface treating pressure, fluid pumping rate, and proppant rate.

14. The one or more non-transitory machine-readable media of claim 8, wherein the recurrent neural network comprises a long short-term memory cell.

15. A system comprising:
a well pump;
a processor,
a machine-readable medium having program code executable by the processor to cause the processor to,
perform a first wellbore treatment operation of a wellbore;
determine an operational attribute of the well in response to the first wellbore treatment operation;
determine a predicted response using a recurrent neural network and based on the operational attribute; and
set a controllable wellbore treatment attribute based on the predicted response; and
perform a second wellbore treatment operation of the wellbore based on the controllable wellbore treatment attribute.

16. The system of claim 15, wherein the program code executable by the processor to determine the predicted response comprises program code to resolve a time and space variation of the predicted response.

17. The system of claim 16, wherein the program code executable by the processor to resolve the time and space variation of the predicted response comprises program code to resolve the time and space variation between the first wellbore treatment operation and the second wellbore treatment operation.

18. The system of claim 15, wherein the program code executable by the processor further comprises program code to cause the processor to:
train, prior to determining the predicted response, the recurrent neural network based on a first value of the operational attribute;
detect that an abnormal wellbore event has occurred; and
in response to detecting the abnormal wellbore event has occurred,
retrain the recurrent neural net work based on a second value of the operational attribute and not based on the first value of the operational attribute, wherein the second value of the operational attribute is determined based on a measurement made after the abnormal wellbore event.

19. The system of claim 15, wherein the program code executable by the processor further comprises program code to cause the processor to determine a formation attribute, wherein determining the predicted response is further based on the formation attribute.

20. The system of claim 15, wherein the controllable wellbore treatment attribute comprises at least one of a surface treating pressure, fluid pumping rate, and proppant rate.
